(19) United States
(12) Patent Application Publication
(10) Pub. No.: US 2021/0185070 A1
(43) Pub. Date: Jun. 17, 2021

(54) LIGHTWEIGHT INTRUSION DETECTION APPARATUS AND METHOD FOR VEHICLE NETWORK

(71) Applicant: Electronics and Telecommunications Research Institute, Daejeon (KR)

(72) Inventors: Boo-Sun JEON, Daejeon (KR); Dong-Wook KANG, Daejeon (KR); Dae-Won KIM, Daejeon (KR); Sang-Woo LEE, Daejeon (KR); Jin-Yong LEE, Daejeon (KR); Bo-Heung CHUNG, Daejeon (KR); Hong-Il JU, Daejeon (KR); Byeong-Cheol CHOI, Daejeon (KR); Joong-Yong CHOI, Sejong-si (KR)

(73) Assignee: Electronics and Telecommunications Research Institute, Daejeon (KR)

(21) Appl. No.: 17/118,090

(22) Filed: Dec. 10, 2020

(30) Foreign Application Priority Data
Dec. 13, 2019 (KR) 10-2019-0166367

(51) Int. Cl. H04L 29/06; G06N 20/00; H04L 12/66; H04L 29/08

(52) U.S. Cl. CPC H04L 63/1425; H04L 63/0263; H04L 63/1458; H04L 2463/142; H04L 12/66; H04L 67/12; G06N 20/00

(57) ABSTRACT

Disclosed herein are a lightweight intrusion detection method and apparatus for a vehicle network. The lightweight intrusion detection method may include collecting Ethernet packets from a domain gateway of a vehicle that provides a mirroring port, performing a primary intrusion detection check on the Ethernet packets using a rule-based intrusion detection technique, and performing a secondary intrusion detection check on the Ethernet packets using a machine learning-based intrusion detection technique when no intrusion attack is detected as a result of the primary intrusion detection check.

### CROSS REFERENCE TO RELATED APPLICATION

This application claims the benefit of Korean Patent Application No. 10-2019-0166367, filed Dec. 13, 2019, which is hereby incorporated by reference in its entirety into this application.

### BACKGROUND OF THE INVENTION

### 1. Technical Field

The present invention relates generally to intrusion detection technology for a vehicle network, and more particularly to technology for detecting intrusion by monitoring an in-vehicle network implemented in a multi-domain network including vehicle Ethernet.

### 2. Description of the Related Art

As autonomous driving service, intelligent services and the like have come to be provided in vehicles, the demand for bandwidth has increased. In order to overcome the various disadvantages of networks such as a Controller Area Network (CAN), a Local Interconnect Network (LIN), FlexRay, and Media Oriented Systems Transport (MOST), Ethernet has begun to be implemented and used in vehicles.

However, with the introduction of the Ethernet in vehicles, communication with external systems is established, and thus the possibility of hacking by a hacker or external intrusion has increased. Because such an attack on a vehicle network has a serious effect on the safety of a passenger, separate security technology is required.

In this case, not all communication of a vehicle is converted into Ethernet. For example, in an existing controller area used for vehicle driving, legacy communication such as existing CAN or LIN communication is used, and in new types of services, such as multimedia service, image service, and intelligent service, Ethernet is used.

However, since a conventional intrusion detection technique for a vehicle network is technology for targeting a legacy network (mainly CAN), it is difficult to apply the conventional technology to vehicles in which the legacy network and the Ethernet-based multi-domain network coexist. Further, since typical Ethernet-based intrusion detection technology does not take into consideration the features of a vehicle, it is difficult to apply such intrusion detection technology to vehicles without change.

### PRIOR ART DOCUMENTS

### Patent Documents

(Patent Document 1) Korean Patent Application Publication No. 10-2018-0021287, Date of Publication: Mar. 2, 2018 (Title: Apparatus and Method for Detecting Vehicle Intrusion)

### SUMMARY OF THE INVENTION

Accordingly, the present invention has been made keeping in mind the above problems occurring in the prior art, and an object of the present invention is to provide a lightweight intrusion detection technique suitable for a vehicle network environment, which is more closed than a typical Ethernet environment and has hardware specifications lower than those of a typical Ethernet environment.

Another object of the present invention is to perform intrusion detection by monitoring traffic transmitted and received through a domain gateway in an in-vehicle network in which the Ethernet and CAN traffic coexist.

A further object of the present invention is to improve the stability of a vehicle by sensing an abnormal packet injected for a fuzzing attack, a Denial-of-Service (DoS) attack or an injection attack delivered against the inside of the vehicle.

In accordance with an aspect of the present invention to accomplish the above objects, there is provided a lightweight intrusion detection method for a vehicle network, including collecting Ethernet packets from a domain gateway of a vehicle that provides a mirroring port; performing a primary intrusion detection check on the Ethernet packets using a rule-based intrusion detection technique; and performing a secondary intrusion detection check on the Ethernet packets using a machine learning-based intrusion detection technique when no intrusion attack is detected as a result of the primary intrusion detection check.

The domain gateway may convert Controller Area Network (CAN) packets in accordance with the Ethernet packets and deliver the converted CAN packets, wherein each CAN packet, converted into a corresponding Ethernet packet, is delivered using any one Ethernet port corresponding to a CAN ID based on a preset one-to-one mapping table.

The rule-based intrusion detection technique may be performed using a rule-based filter that is generated based on a value of a preset field having fixed characteristics, among amounts of traffic related to the vehicle.

Performing the secondary intrusion detection check may include extracting statistical features of Ethernet packets collected within a preset time window; and performing a machine learning-based intrusion detection check by inputting the statistical features to a previously learned intrusion detection checking model.

The primary intrusion detection check and the secondary intrusion detection check may be performed by at least one of the domain gateway and an intrusion detection apparatus connected to the domain gateway through the mirroring port.

The intrusion detection method may further include measuring a CAN packet period for detecting a Denial-of-Service (DoS) attack and a fuzzing attack in consideration of periods of packets that are input for respective Ethernet ports.

In accordance with another aspect of the present invention to accomplish the above objects, there is provided a lightweight intrusion detection apparatus for a vehicle network, including a processor for collecting Ethernet packets from a domain gateway of a vehicle that provides a mirroring port, performing a primary intrusion detection check on the Ethernet packets using a rule-based intrusion detection technique, and performing a secondary intrusion detection check on the Ethernet packets using a machine learning-based intrusion detection technique when no intrusion attack is detected as a result of the primary intrusion detection check; and a memory for storing the Ethernet packets.

The domain gateway may convert Controller Area Network (CAN) packets in accordance with the Ethernet packets and deliver the converted CAN packets, wherein each CAN packet, converted into a corresponding Ethernet packet, is delivered using any one Ethernet port corresponding to a CAN ID based on a preset one-to-one mapping table.

The rule-based intrusion detection technique may be performed using a rule-based filter that is generated based on a value of a preset field having fixed characteristics, among amounts of traffic related to the vehicle.

The processor may extract statistical features of Ethernet packets collected within a preset time window, and then perform a machine learning-based intrusion detection check by inputting the statistical features to a previously learned intrusion detection checking model.

The primary intrusion detection check and the secondary intrusion detection check may be performed by at least one of the domain gateway and the intrusion detection apparatus connected to the domain gateway through the mirroring port.

The processor may measure a CAN packet period for detecting a Denial-of-Service (DoS) attack and a fuzzing attack in consideration of periods of packets that are input for respective Ethernet ports.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating an example of a multi-domain in-vehicle network based on Ethernet;

FIG. 2 is a block diagram illustrating an example of the domain gateway illustrated in FIG. 1;

FIGS. 3 and 4 are diagrams illustrating an intrusion detection system according to an embodiment of the present invention;

FIG. 5 is an operation flowchart illustrating a lightweight intrusion detection method for a vehicle network according to an embodiment of the present invention;

FIG. 6 is a diagram illustrating an example in which a domain gateway converts a CAN packet into an Ethernet packet according to the present invention;

FIG. 7 is a diagram illustrating an example of CAN packets and Ethernet ports mapped to each other in one-to-one correspondence according to the present invention;

FIGS. 8 and 9 are diagrams illustrating an example of a one-to-one mapping table according to the present invention;

FIG. 10 is a diagram illustrating an example of a double intrusion detection process according to the present invention;

FIGS. 11 to 14 are diagrams illustrating examples of the structure of an intrusion detection system according to the present invention;

FIG. 15 is an operation flowchart illustrating in detail a lightweight intrusion detection method for a vehicle network according to an embodiment of the present invention; and

FIG. 16 is a block diagram illustrating a lightweight intrusion detection apparatus for a vehicle network according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention to are intended to fully describe the present invention to a person having ordinary knowledge in the art to which the present invention pertains. Accordingly, the shapes, sizes, etc. of components in the drawings may be exaggerated to make the description clearer.

Hereinafter, preferred embodiments of the present invention will be described in detail with reference to the attached drawings.

FIG. 5 is an operation flowchart illustrating a lightweight intrusion detection method for a vehicle network according to an embodiment of the present invention.

Since conventional intrusion detection systems for vehicles target a Controller Area Network (CAN), there is a limitation in that they cannot be applied to vehicles based on a multi-domain network. Also, since electronic control devices mounted in vehicles are sensitive to cost, there are many cases where installed computing power resources or resources such as memory satisfy only minimum hardware specifications. Therefore, the intrusion detection system for vehicles must be able to achieve real-time processing speed using only minimum computing power and memory.

Therefore, the present invention is intended to propose lightweight intrusion detection technology for a vehicle network, which can overcome such limitations and effectively perform intrusion detection.

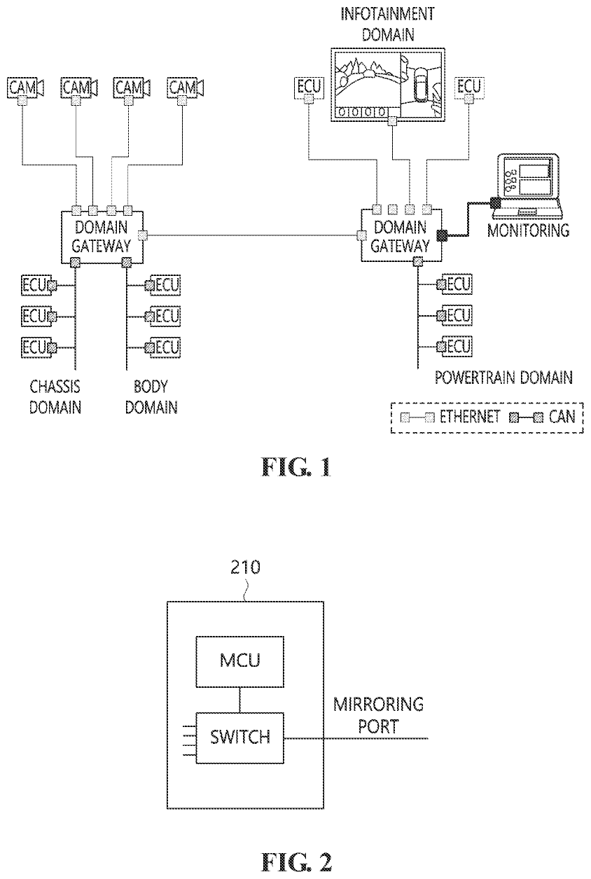

Generally, an in-vehicle network may be configured as illustrated in FIG. 1. Referring to FIG. 1, the domain gateway of the vehicle may function to switch and deliver Ethernet packets and to convert data of a legacy network such as a Controller Area Network (CAN) into Ethernet packets and deliver the Ethernet packets.

Therefore, the domain gateway may be configured in a form such as that illustrated in FIG. 2 in order to perform the above-described functions. That is, a domain gateway 210 may be composed of an Ethernet switch and a microcontroller unit (MCU), and may duplicate all packets flowing therein over a legacy network and an Ethernet network and transmit the duplicated packets to a mirroring port so that the intrusion detection system can monitor the networks.

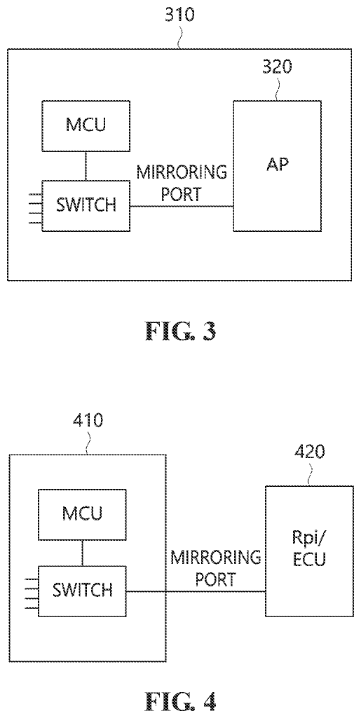

Here, because there are many cases where an MCU for vehicles, meeting only minimum hardware specifications, is mounted for reasons such as cost reduction, the MCU may take charge only of the function of the domain gateway in most cases. Therefore, the intrusion detection system is often operated on a separate intrusion detection application 320 or an intrusion detection module 420 as illustrated in FIG. 3 or 4, rather than being mounted in the MCU of the gateway.

In this way, the intrusion detection system may be implemented in such a way that a separate Access Point (AP) is mounted on the domain gateway which provides a mirroring port (wherein this system is called a Connectivity Central Unit (CCU)). Alternatively, an intrusion detection apparatus may be implemented to be manufactured in the form of a separate processor, such as a Raspberry Pi, or a separate Electronic Control Unit (ECU).

However, there are many cases where such conventional intrusion detection technology for vehicles is targeting only a CAN. Further, common Ethernet-based intrusion detection technology is disadvantageous in that it is too heavy to be applied to vehicles, thus making it difficult to implement this technology in a vehicle controller environment, characterized by low computing power and small memory.

Therefore, in consideration of this vehicle controller environment, the present invention proposes a lightweight intrusion detection technique in which an intrusion detection system is designed to be lightweight so that it is operable even on hardware having low specifications and to satisfy the real-time characteristic of vehicles.

Referring to FIG. 5, the lightweight intrusion detection method for a vehicle network according to an embodiment of the present invention collects Ethernet packets from the domain gateway of the vehicle, which provides a mirroring port, at step S510.

Here, the domain gateway converts CAN packets in accordance with Ethernet packets and delivers the converted packets, wherein each CAN packet, converted into the corresponding Ethernet packet, may be delivered using any one Ethernet port corresponding to a CAN ID based on a preset one-to-one mapping table.

For example, a large number of Ethernet packets, such as image data, and CAN packets, containing a small number of CAN messages generated by a controller, may be delivered together to the domain gateway on a vehicle network to which the vehicle Ethernet is applied.

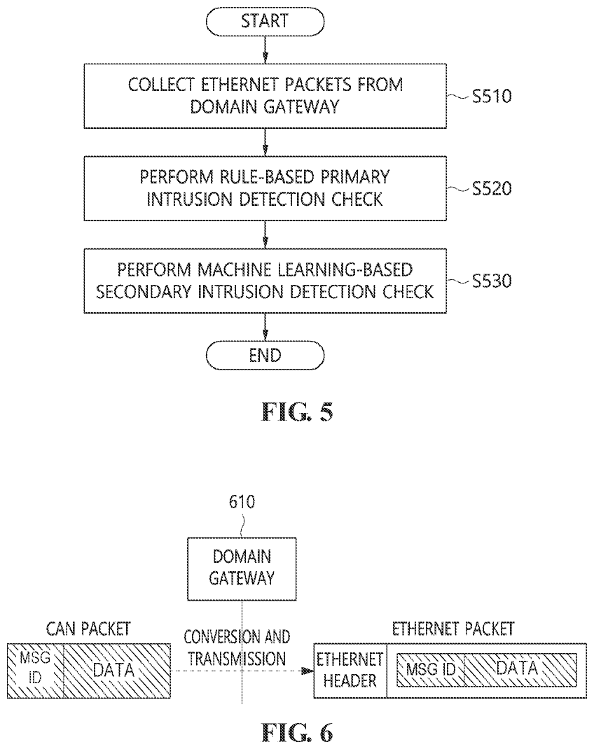

Here, the CAN messages may each be composed of a Message (Msg) ID and data, and may have the characteristics of being generated at intervals of the period such as 10 ms, 20 ms, 50 ms, 100 ms, or 200 ms depending on the Msg ID. This real-time characteristic data may be converted by a domain gateway 610 into a format in which an Msg ID and data are contained in the payload portion of each Ethernet packet, and then the Ethernet packet may be generated, as illustrated in FIG. 6.

However, due to the specification of a low-specification vehicle controller, individually observing the payload portion of each message delivered from the controller with real-time characteristics at intervals of a short period may cause a burdensome load.

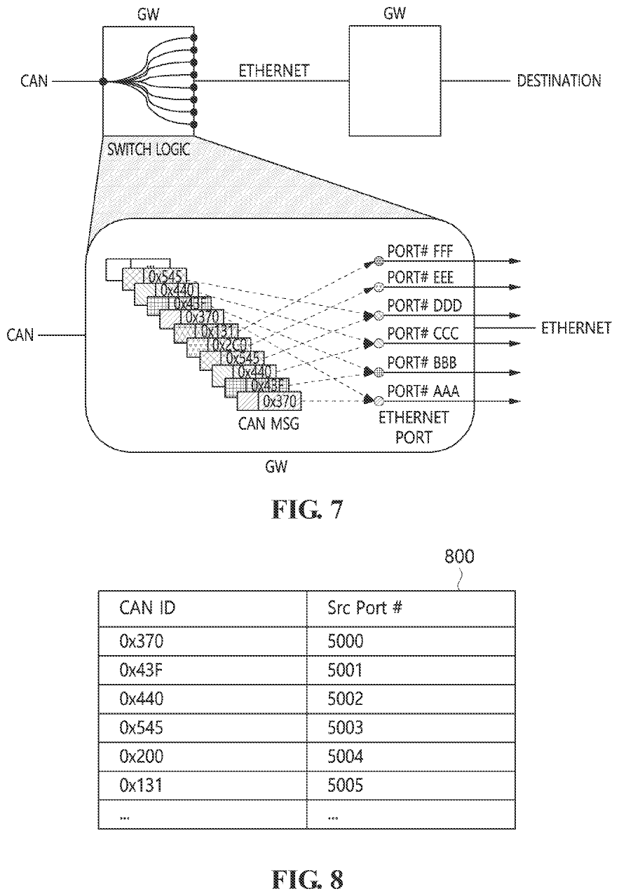

Therefore, in the domain gateway according to the present invention, when a CAN message is converted into an Ethernet packet and the Ethernet packet is transmitted, the Ethernet packet may be transmitted with the Msg ID of the CAN message mapped to an Ethernet source port (SrcPort) number in one-to-one (1:1) correspondence, as illustrated in FIG. 7.

At this time, after each CAN message has been converted into an Ethernet packet, multiple CAN messages may be sent through one connection, but the intrusion detection system has a limitation in that the payload portions of respective Ethernet packets must be individually observed so as to monitor the characteristics of the CAN messages. However, when the domain gateway transmits the Ethernet packet so that each CAN message (Msg) ID is mapped to a SrcPort number in one-to-one correspondence based on the method presented by the present invention, the intrusion detection system may identify the corresponding CAN Msg ID using only a SrcPort number present in a packet header, even without inspecting the data area of the Ethernet packet.

In this case, the domain gateway may deliver the converted CAN packet to any one Ethernet port corresponding to the CAN ID of the CAN packet with reference to a preset one-to-one mapping table.

For example, the domain gateway may manage a one-to-one mapping table 800, in which CAN IDs and source port (SrcPort) numbers are mapped to each other, as illustrated in FIG. 8.

Further, although not illustrated in FIG. 5, the lightweight intrusion detection method for a vehicle network according to the embodiment of the present invention may measure a CAN packet period for detecting a DoS attack and a fuzzing attack in consideration of the periods of packets that are input for respective Ethernet ports.

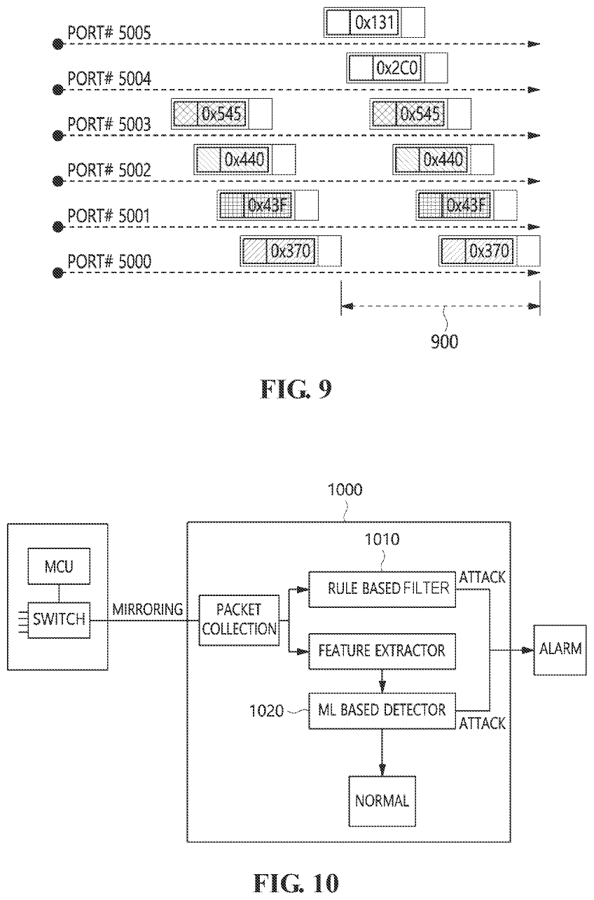

For example, CAN messages have the characteristics of being sent at a regular period and at a uniform frequency. Accordingly, as illustrated in FIG. 8, when packets are received by establishing the one-to-one mapping table 800, the period 900 or frequency of CAN packets transmitted or received for respective source ports (SrcPort) may be easily measured, as illustrated in FIG. 9. By means thereof, on the Ethernet, a DoS attack, a fuzzing attack or the like caused by CAN messages may be easily detected.

Next, the lightweight intrusion detection method for a vehicle network according to the embodiment of the present invention performs a primary intrusion detection check on the Ethernet packets using a rule-based intrusion detection technique at step S520.

Here, the rule-based intrusion detection technique may be performed using a rule-based filter that is generated based on the value of a preset field having fixed characteristics, among amounts of traffic related to the vehicle.

Generally, since an in-vehicle network has a fixed structure, a new node is hardly added, and initial settings made at the time of releasing the corresponding vehicle remain unchanged in most cases. A portion having a fixed value through a network header has many fields in which static values falling within predefined ranges appear. When unfamiliar values are input to such fields, it may be primarily suspected that intrusion has occurred.

For example, in fields such as a Priority Code Point (PCP) field, a Drop Eligible Indicator (DEI) field, and a Virtual Local Area Network (VLAN) Identifier (ID) field, which are VLAN-related fields, fixed values are transmitted. Further, a Generalized Precision Time Protocol (gPTP) packet for time synchronization of Audio/Video Bridging (AVB) traffic may be transmitted to include either one value, in which values such as transportSpecific, versionPTP, domainNumber, sequenceID, messageType, messageLength, Flags, controlField, and logMessagelnterval are fixed, or one of several fixed values. Furthermore, the Audio/Video Transport Protocol Delivery Unit (AVTPDU) packet of AVB traffic may be transmitted to include either one value, in which values such as the values of subtype, stream_id valid (sv), version, media clock restart (mr), gateway_info field valid (gv), avtp timestamp valid (tv), reserved(r), stream id, and gateway_info are fixed, or one of several fixed values.

Furthermore, the source media access control address (Src MAC address) or destination (Dest) MAC address of each packet transmitted through the domain gateway may have an almost fixed set, considering the characteristics of the vehicle in which a network topology is hardly changed. In the above-described values, when values which did not appear in previous data observation are observed, an abnormal symptom may be considered to occur based on a static rule.

For example, there is a reserved field that has been defined for compatibility, but is not used. When a specific value is input to the reserved field, it may be determined that a fuzzing attack or the like has been made. Alternatively, when data is transmitted from a location with a MAC address at which data is not usually transmitted, it may be suspected that intrusion has occurred.

In this way, rule-based intrusion detection may be simply performed using the traffic characteristics only of the vehicle, and an alarm against an attack may be generated when intrusion is detected.

Further, when an intrusion attack is not detected as a result of the primary intrusion detection check, the lightweight intrusion detection method for a vehicle network according to the embodiment of the present invention performs a secondary intrusion detection check on the Ethernet packets using a machine learning-based intrusion detection technique at step S530.

An attack that is previously unknown may also be detected by performing the secondary intrusion detection check.

Here, statistical features of Ethernet packets that are collected within a preset time window may be extracted, and may be input to a previously learned intrusion detection checking model, and thus a machine learning-based intrusion detection check may be performed.

For example, when intrusion detection is performed through machine learning, individually determining each packet may increase an overhead in the environment of a vehicle having low computing power.

Therefore, in the present invention, primary features, such as those shown in Table 1, may be extracted from respective packets, and statistical features, such as those shown in Table 2, may be extracted within a suitable time window based on the extracted primary features, and may be trained as the features of machine learning.

TABLE 1

| Primary feature | Description |
|---|---|
| Index | Index information of packet |
| Timestamp | Reception time information of packet |
| Src_mac | Transmitter (source) MAC address |
| Multicast | Whether multicast/broadcast is to be used |
| Dst_mac | Receiver (destination) MAC address |
| Pkt_len | Total length of packet |
| Pkt_type | Packet type based on Ethernet header |
| Interval_back | Reception time interval from previous packet |

Here, secondary statistical data such as those shown in Table 2 may be extracted from the primary feature data such as those shown in Table 1.

TABLE 2

| Statistical Feature | Description |
|---|---|
| BPS | Number of bits per second within time window |
| PPS | Number of packets per second within time window |
| Avg_interval | Average time interval between packets within time |
| | window |
| Multicast_num | Number of multicasted or broadcasted packets within |
| | time window |
| Src_num | Number of source addresses within time window |
| Dst_num | Number of destination addresses within time window |
| Src_dst_num | Number of source-destination address pairs within |
| | time window |
| Proto_num | Number of protocol types within time window |

As an algorithm for performing such machine learning, an algorithm that is capable of sorting classes and has a relatively short learning and evaluation time may be used. For example, an algorithm, such as a Support Vector Machine (SVM), K-Nearest Neighbors (KNN), Stochastic Gradient Descent (SGD), or Gradient Boosting Classifier (GBC), may be used, and any other machine-learning algorithms may also be used in addition to those algorithms.

Further, the size of the time window for extracting the secondary statistical data may be set to a parameter value, and may then be set suitably for a vehicle network to which the present invention is applied.

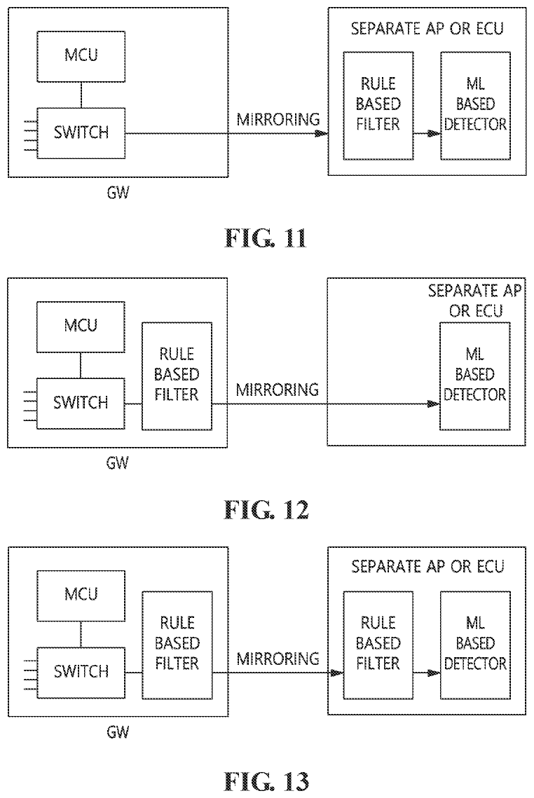

In this way, the present invention may perform double intrusion detection using static rule-based filtering and a machine-learning technique, and this process may be simply illustrated, as illustrated in FIG. 10.

That is, an intrusion detection module 1000 according to an embodiment of the present invention may detect whether an intrusion attack has been made by performing a primary intrusion detection check using a rule-based filter 1010. Here, when a separate attack is not detected by the rule-based filter 1010, a secondary intrusion detection check may be performed using a machine learning (ML)-based checking model (i.e., an ML-based detector) 1020 through a procedure for extracting the statistical features of the collected packets.

By means of this double detection structure, an intrusion detection system having high performance may be implemented even in a low-specification vehicle control system.

Here, the primary intrusion detection check and the secondary intrusion detection check may be performed by at least one of the domain gateway and an intrusion detection apparatus connected to the domain gateway through the mirroring port.

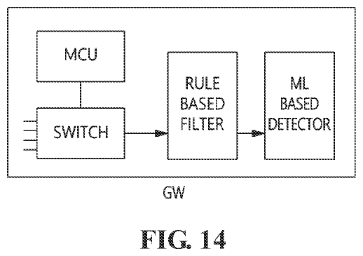

For example, the present invention may be operated in various schemes such as in the case where both the rule-based filter and the machine learning-based checking model (ML-based detector) are located in a separate AP or ECU for intrusion detection, as illustrated in FIG. 11, the case where the rule-based filter is arranged in the domain gateway so as to minimize mirroring, as illustrated in FIG. 12, the case where the rule-based filter is divided and arranged both in the domain gateway and in the intrusion detection system, as illustrated in FIG. 13, and the case where all intrusion detection system-related components are arranged to be included in the domain gateway, as illustrated in FIG. 14.

Here, as illustrated in FIG. 12, when the rule-based filter is arranged in the domain gateway, only primarily passed packets may be mirrored without applying a large load to the domain gateway, thus obtaining the effect of greatly reducing a load.

Also, the structure for dividing the rule-based filter and arranging it both in the domain gateway and in the intrusion detection system, as illustrated in FIG. 13, may load some rules that are either frequently used or important in the rule-based filter into the domain gateway, and may allow the remaining rules to be operated in a separate AP or ECU. The arrangement of such rule-based filter is advantageous in that it may reduce a mirroring load while minimizing the burden of the domain gateway, and may promptly respond to the corresponding situation by allowing the domain gateway to immediately sense important data.

Here, the rules loaded into the domain gateway and the rules operated in the separate AP or ECU may be divided and classified depending on whether real-time characteristics are supported, the generation period of data (10 ms/20 ms/50 ms/100 ms/200 ms, etc.), each domain of an in-vehicle network, the importance of ECUs, etc.

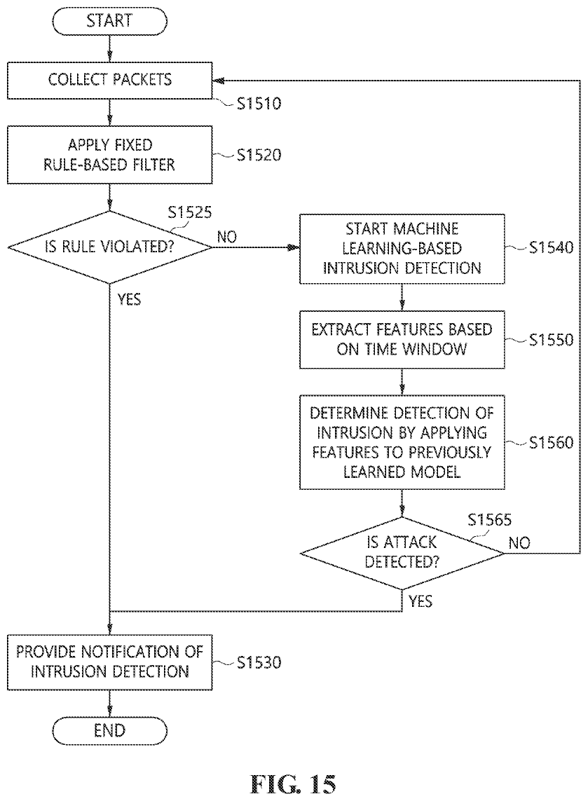

The above-described double intrusion detection process is described in detail below with reference to FIG. 15. First, Ethernet packets that are delivered to an in-vehicle network through the domain gateway of a vehicle are collected at step S1510, and a fixed rule-based filter is applied to the collected Ethernet packets at step S1520, and thus whether an Ethernet packet violating a certain rule is present may be primarily determined at step S1525.

If it is determined at step S1525 that there is the Ethernet packet violating the rule, notification of the occurrence of an intrusion attack may be provided to the inside of the vehicle by generating an intrusion detection alarm at step S1530.

In contrast, if it is determined at step S1525 that there is no Ethernet packet violating the rule, machine learning-based intrusion detection may be secondarily performed at step S1540.

Here, statistical features may be extracted from the Ethernet packets based on a time window set suitably for the vehicle at step S1550, and whether intrusion has been detected may be determined by inputting the extracted statistical features to a previously learned intrusion detection checking model at step S1560.

Thereafter, whether an attack on the vehicle has been detected is determined through machine learning-based intrusion detection at step S1565. If it is determined that no attack has been detected, an intrusion detection process starting from the step of collecting Ethernet packets may be repeatedly performed.

If it is determined at step S1565 that the attack has been detected, notification of the occurrence of an intrusion attack may be provided to the inside of the vehicle by generating an intrusion detection alarm at step S1530.

The intrusion detection system according to the embodiment of the present invention, implemented through the above-described process, may be implemented to be more lightweight than conventional Ethernet-based models, and may then be used as an efficient intrusion detection system for vehicles.

Further, although not illustrated in FIG. 5, the lightweight intrusion detection method for a vehicle network according to an embodiment of the present invention may store various types of information generated during the above-described intrusion detection process in a separate storage module.

By means of the lightweight intrusion detection method for a vehicle network, intrusion detection may be effectively performed in a vehicle network environment, which is more closed than a typical Ethernet environment and has hardware specifications lower than those of a typical Ethernet environment.

Further, the present invention may improve the stability of a vehicle by sensing an abnormal packet injected for a fuzzing attack, a DoS attack or an injection attack delivered against the vehicle.

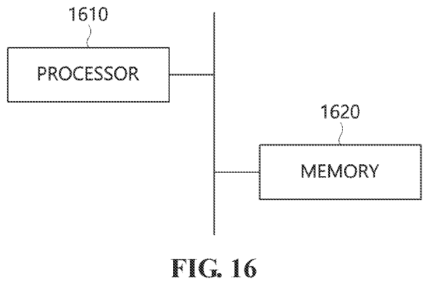

FIG. 16 is a block diagram illustrating a lightweight intrusion detection apparatus for a vehicle network according to an embodiment of the present invention.

Referring to FIG. 16, the lightweight intrusion detection apparatus for a vehicle network according to the embodiment of the present invention may include a processor 1610 and memory 1620.

The processor 1610 collects Ethernet packets from the domain gateway of the vehicle, which provides a mirroring port.

Here, the domain gateway converts CAN packets in accordance with Ethernet packets and delivers the converted packets, wherein each CAN packet, converted into the corresponding Ethernet packet, may be delivered using any one Ethernet port corresponding to a CAN ID based on a preset one-to-one mapping table.

For example, a large number of Ethernet packets, such as image data, and CAN packets, containing a small number of CAN messages generated by a controller, may be delivered together to the domain gateway on a vehicle network to which the vehicle Ethernet is applied.

Here, the CAN messages may each be composed of a Message (Msg) ID and data, and may have the characteristics of being generated at intervals of the period such as 10 ms, 20 ms, 50 ms, 100 ms, or 200 ms depending on the Msg ID. This real-time characteristic data may be converted by a domain gateway 610 into a format in which an Msg ID and data are contained in the payload portion of each Ethernet packet, and then the Ethernet packet may be generated, as illustrated in FIG. 6.

However, due to the specification of a low-specification vehicle controller, individually observing the payload portion of each message delivered from the controller with real-time characteristics at intervals of a short period may cause a burdensome load.

Therefore, in the domain gateway according to the present invention, when each CAN message is converted into an Ethernet packet and the Ethernet packet is transmitted, the Ethernet packet may be transmitted with the Msg ID of the CAN message mapped to an Ethernet source port (SrcPort) number in one-to-one (1:1) correspondence, as illustrated in FIG. 7.

At this time, after each CAN message has been converted into an Ethernet packet, multiple CAN messages may be sent through one connection, but the intrusion detection system has a limitation in that the payload portions of respective Ethernet packets must be individually observed so as to monitor the characteristics of the CAN messages. However, when the domain gateway transmits the Ethernet packet so that each CAN message (Msg) ID is mapped to a SrcPort number in one-to-one correspondence based on the method presented by the present invention, the intrusion detection system may identify the corresponding CAN Msg ID using only a SrcPort number present in a packet header, even without inspecting the data area of the Ethernet packet.

In this case, the domain gateway may deliver each CAN packet, converted into the corresponding Ethernet packet, to any one Ethernet port corresponding to the CAN ID of the CAN packet with reference to a preset one-to-one mapping table.

For example, the domain gateway may manage a one-to-one mapping table 800, in which CAN IDs and source port (SrcPort) numbers are mapped to each other, as illustrated in FIG. 8.

Further, the processor 1610 may measure a CAN packet period for detecting a DoS attack and a fuzzing attack in consideration of the periods of packets that are input for respective Ethernet ports.

For example, CAN messages have the characteristics of being sent at a regular period and at a uniform frequency. Accordingly, as illustrated in FIG. 8, when packets are received by establishing the one-to-one mapping table 800, the period 900 or frequency of CAN packets transmitted or received for respective source ports (SrcPort) may be easily measured, as illustrated in FIG. 9. By means thereof, on the Ethernet, a DoS attack, a fuzzing attack or the like caused by CAN messages may be easily detected.

Furthermore, the processor 1610 performs a primary intrusion detection check on the Ethernet packets using a rule-based intrusion detection technique.

Here, the rule-based intrusion detection technique may be performed using a rule-based filter that is generated based on the value of a preset field having fixed characteristics, among amounts of traffic related to the vehicle.

Generally, since an in-vehicle network has a fixed structure, a new node is hardly added, and initial settings made at the time of releasing the corresponding vehicle remain unchanged in most cases. A portion having a fixed value through a network header has many fields in which static values falling within predefined ranges appear. When unfamiliar values are input to such fields, it may be primarily suspected that intrusion has occurred.

For example, in fields such as a Priority Code Point (PCP) field, a Drop Eligible Indicator (DEI) field, and a Virtual Local Area Network (VLAN) Identifier (ID) field, which are VLAN-related fields, fixed values are transmitted. Further, a Generalized Precision Time Protocol (gPTP) packet for time synchronization of Audio/Video Bridging (AVB) traffic may be transmitted to include either one value, in which values such as transportSpecific, versionPTP, domainNumber, sequenceID, messageType, messageLength, Flags, controlField, and logMessagelnterval are fixed, or one of several fixed values. Furthermore, the Audio/Video Transport Protocol Delivery Unit (AVTPDU) packet of AVB traffic may be transmitted to include either one value, in which values such as the values of subtype, stream_id valid (sv), version, media clock restart (mr), gateway_info field valid (gv), avtp timestamp valid (tv), reserved(r), stream id, and gateway_info are fixed, or one of several fixed values.

Furthermore, the source media access control address (Src MAC address) or destination (Dest) MAC address of each packet transmitted through the domain gateway may have an almost fixed set, considering the characteristics of the vehicle in which a network topology is hardly changed. In the above-described values, when values which did not appear in previous data observation are observed, an abnormal symptom may be considered to occur based on a static rule.

For example, there is a reserved field that has been defined for compatibility, but is not used. When a specific value is input to the reserved field, it may be determined that a fuzzing attack or the like has been made. Alternatively, when data is transmitted from a location with a MAC address at which data is not usually transmitted, it may be suspected that intrusion has occurred.

In this way, rule-based intrusion detection may be simply performed using the traffic characteristics only of the vehicle, and an alarm against an attack may be generated when intrusion is detected.

Further, when an intrusion attack is not detected as a result of the primary intrusion detection check, the processor 1610 performs a secondary intrusion detection check on the Ethernet packets using a machine learning-based intrusion detection technique.

An attack that is previously unknown may also be detected by performing the secondary intrusion detection check.

Here, statistical features of Ethernet packets that are collected within a preset time window may be extracted, and may be input to a previously learned intrusion detection checking model, and thus a machine learning-based intrusion detection check may be performed.

For example, when intrusion detection is performed through machine learning, individually determining each packet may increase an overhead in the environment of a vehicle having low computing power.

Therefore, in the present invention, primary features, such as those shown in the foregoing Table 1, may be extracted from respective packets, and statistical features, such as those shown in the foregoing Table 2, may be extracted within a suitable time window based on the extracted primary features, and may be trained as the features of machine learning.

Here, secondary statistical data such as those shown in Table 2 may be extracted from the primary feature data such as those shown in Table 1.

As an algorithm for performing such machine learning, an algorithm that is capable of sorting classes and has a relatively short learning and evaluation time may be used. For example, an algorithm, such as a Support Vector Machine (SVM), K-Nearest Neighbors (KNN), Stochastic Gradient Descent (SGD), or Gradient Boosting Classifier (GBC), may be used, and any other machine-learning algorithms may also be used in addition to those algorithms.

Further, the size of the time window for extracting the secondary statistical data may be set to a parameter value, and may then be set suitably for a vehicle network to which the present invention is applied.

In this way, the present invention may perform double intrusion detection using static rule-based filtering and a machine-learning technique, and this process may be simply illustrated, as illustrated in FIG. 10.

That is, an intrusion detection module 1000 according to an embodiment of the present invention may detect whether an intrusion attack has been made by performing a primary intrusion detection check using a rule-based filter 1010. Here, when a separate attack is not detected by the rule-based filter 1010, a secondary intrusion detection check may be performed using a machine learning (ML)-based checking model (i.e., an ML-based detector) 1020 through a procedure for extracting the statistical features of the collected packets.

By means of this double detection structure, an intrusion detection system having high performance may be implemented even in a low-specification vehicle control system.

Here, the primary intrusion detection check and the secondary intrusion detection check may be performed by at least one of the domain gateway and an intrusion detection apparatus connected to the domain gateway through the mirroring port.

For example, the present invention may be operated in various schemes such as in the case where both the rule-based filter and the machine learning-based checking model are located in a separate AP or ECU for intrusion detection, as illustrated in FIG. 11, the case where the rule-based filter is arranged in the domain gateway so as to minimize mirroring, as illustrated in FIG. 12, the case where the rule-based filter is divided and arranged both in the domain gateway and in the intrusion detection system, as illustrated in FIG. 13, and the case where all intrusion detection system-related components are arranged to be included in the domain gateway, as illustrated in FIG. 14.

Here, as illustrated in FIG. 12, when the rule-based filter is arranged in the domain gateway, only primarily passed packets may be mirrored without applying a large load to the domain gateway, thus obtaining the effect of greatly reducing a load.

Also, the structure for dividing the rule-based filter and arranging it both in the domain gateway and in the intrusion detection system, as illustrated in FIG. 13, may load some rules that are either frequently used or important in the rule-based filter into the domain gateway, and may allow the remaining rules to be operated in a separate AP or ECU. The arrangement of such rule-based filter is advantageous in that it may reduce a mirroring load while minimizing the burden of the domain gateway, and may promptly respond to the corresponding situation by allowing the domain gateway to immediately sense important data.

Here, the rules loaded into the domain gateway and the rules operated in the separate AP or ECU may be divided and classified depending on whether real-time characteristics are supported, the generation period of data (10 ms/20 ms/50 ms/100 ms/200 ms, etc.), each domain of an in-vehicle network, the importance of ECUs, etc.

The above-described double intrusion detection process is described in detail below with reference to FIG. 15. First, Ethernet packets that are delivered to an in-vehicle network through the domain gateway of a vehicle are collected at step S1510, and a fixed rule-based filter is applied to the collected Ethernet packets at step S1520, and thus whether an Ethernet packet violating a certain rule is present may be primarily determined at step S1525.

If it is determined at step S1525 that there is the Ethernet packet violating the rule, notification of the occurrence of an intrusion attack may be provided to the inside of the vehicle by generating an intrusion detection alarm at step S1530.

In contrast, if it is determined at step S1525 that there is no Ethernet packet violating the rule, machine learning-based intrusion detection may be secondarily performed at step S1540.

Here, statistical features may be extracted from the Ethernet packets based on a time window set suitably for the vehicle at step S1550, and whether intrusion has been detected may be determined by inputting the extracted statistical features to a previously learned intrusion detection checking model at step S1560.

Thereafter, whether an attack on the vehicle has been detected is determined through machine learning-based intrusion detection at step S1565. If it is determined that no attack has been detected, an intrusion detection process starting from the step of collecting Ethernet packets may be repeatedly performed.

If it is determined at step S1565 that the attack has been detected, notification of the occurrence of an intrusion attack may be provided to the inside of the vehicle by generating an intrusion detection alarm at step S1530.

The intrusion detection system according to the embodiment of the present invention, implemented through the above-described process, may be implemented to be more lightweight than conventional Ethernet-based models, and may then be used as an efficient intrusion detection system for vehicles.

The memory 1620 stores the collected Ethernet packets.

Also, the memory 1620 stores various types of information generated during the intrusion detection process according to the embodiment of the present invention, as described above.

In accordance with an embodiment, the memory 1620 may be operated as separate large-capacity (mass) storage, and may also include a control function for performing operations.

By utilizing the lightweight intrusion detection apparatus for a vehicle network, intrusion detection may be effectively performed in a vehicle network environment, which is more closed than a typical Ethernet environment and has hardware specifications lower than those of a typical Ethernet environment.

Further, the present invention may improve the stability of a vehicle by sensing an abnormal packet injected for a fuzzing attack, a DoS attack or an injection attack delivered against the vehicle.

In accordance with the present invention, there can be provided a lightweight intrusion detection technique suitable for a vehicle network environment, which is more closed than a typical Ethernet environment and has hardware specifications lower than those of a typical Ethernet environment.

Further, the present invention may perform intrusion detection by monitoring traffic transmitted and received through a domain gateway in an in-vehicle network in which the Ethernet and CAN traffic coexist.

Furthermore, the present invention may improve the stability of a vehicle by sensing an abnormal packet injected for a fuzzing attack, a Denial-of-Service (DoS) attack or an injection attack delivered against the inside of the vehicle.

As described above, in the lightweight intrusion detection method and apparatus for a vehicle network according to the present invention, the configurations and schemes in the above-described embodiments are not limitedly applied, and some or all of the above embodiments can be selectively combined and configured such that various modifications are possible.

What is claimed is:

1. A intrusion detection method for a vehicle network, comprising:
collecting Ethernet packets from a domain gateway of a vehicle that provides a mirroring port;
performing a primary intrusion detection check on the Ethernet packets using a rule-based intrusion detection technique; and
performing a secondary intrusion detection check on the Ethernet packets using a machine learning-based intrusion detection technique when no intrusion attack is detected as a result of the primary intrusion detection check.

2. The intrusion detection method of claim 1, wherein the domain gateway converts Controller Area Network (CAN) packets in accordance with the Ethernet packets and delivers the converted CAN packets, wherein each CAN packet, converted into a corresponding Ethernet packet, is delivered using any one Ethernet port corresponding to a CAN ID based on a preset one-to-one mapping table.

3. The intrusion detection method of claim 1, wherein the rule-based intrusion detection technique is performed using a rule-based filter that is generated based on a value of a preset field having fixed characteristics, among amounts of traffic related to the vehicle.

4. The intrusion detection method of claim 1, wherein performing the secondary intrusion detection check comprises:
extracting statistical features of Ethernet packets collected within a preset time window; and
performing a machine learning-based intrusion detection check by inputting the statistical features to a previously learned intrusion detection checking model.

5. The intrusion detection method of claim 1, wherein the primary intrusion detection check and the secondary intrusion detection check are performed by at least one of the domain gateway and an intrusion detection apparatus connected to the domain gateway through the mirroring port.

6. The intrusion detection method of claim 2, further comprising measuring a CAN packet period for detecting a Denial-of-Service (DoS) attack and a fuzzing attack in consideration of periods of packets that are input for respective Ethernet ports.

7. A intrusion detection apparatus for a vehicle network, comprising:
a processor for collecting Ethernet packets from a domain gateway of a vehicle that provides a mirroring port, performing a primary intrusion detection check on the Ethernet packets using a rule-based intrusion detection technique, and performing a secondary intrusion detection check on the Ethernet packets using a machine learning-based intrusion detection technique when no intrusion attack is detected as a result of the primary intrusion detection check; and
a memory for storing the Ethernet packets.

8. The intrusion detection apparatus of claim 7, wherein the domain gateway converts Controller Area Network (CAN) packets in accordance with the Ethernet packets and delivers the converted CAN packets, wherein each CAN packet, converted into a corresponding Ethernet packet, is delivered using any one Ethernet port corresponding to a CAN ID based on a preset one-to-one mapping table.

9. The intrusion detection apparatus of claim 7, wherein the rule-based intrusion detection technique is performed using a rule-based filter that is generated based on a value of a preset field having fixed characteristics, among amounts of traffic related to the vehicle.

10. The intrusion detection apparatus of claim 7, wherein the processor extracts statistical features of Ethernet packets collected within a preset time window, and then performs a machine learning-based intrusion detection check by inputting the statistical features to a previously learned intrusion detection checking model.

11. The intrusion detection apparatus of claim 7, wherein the primary intrusion detection check and the secondary intrusion detection check are performed by at least one of the domain gateway and the intrusion detection apparatus connected to the domain gateway through the mirroring port.

12. The intrusion detection apparatus of claim 8, wherein the processor measures a CAN packet period for detecting a Denial-of-Service (DoS) attack and a fuzzing attack in consideration of periods of packets that are input for respective Ethernet ports.
